(19) United States
(12) Patent Application Publication
(10) Pub. No.: US 2014/0146228 A1
(43) Pub. Date: May 29, 2014

(54) VIDEO CAMERA DRIVING CIRCUIT AND METHOD THEREOF

(71) Applicant: VIVOTECK INC., New Taipei City (TW)

(72) Inventor: Tzu-Yang TSAI, New Taipei City (TW)

(73) Assignee: VIVOTECK INC., New Taipei City (TW)

(21) Appl. No.: 14/084,158

(22) Filed: Nov. 19, 2013

(30) Foreign Application Priority Data
Nov. 23, 2012 (TW) 101144040

(51) Int. Cl. H04N 5/225

(52) U.S. Cl. CPC H04N 5/2254
USPC 348/374

(57) ABSTRACT

A video camera driving circuit and a method thereof are provided, where the video camera driving circuit includes a connector, a determination unit and a control chip. The connector outputs an identification signal specifying either a first lens or a second lens which the connector connects to. The determination unit outputs a determination signal according to the identification signal and a reference voltage. The control chip outputs a control signal according to the determination signal.

### CROSS-REFERENCE TO RELATED APPLICATIONS

This non-provisional application claims priority under 35 U.S.C. §119(a) on Patent Application No(s). 101144040 filed in Taiwan, R.O.C. on Nov. 23, 2012, the entire contents of which are hereby incorporated by reference.

### TECHNICAL FIELD

The disclosure relates to a driving circuit, more particularly to a video camera driving circuit and a method thereof.

### BACKGROUND

Because digital data is easily processed and stored and digitalized equipment is stable and easily controlled more than non-digitalized equipment or data, a digital video recorder (DVR) applied to digital security surveillance equipment and cooperating with a computer system is replacing the conventional closed circuit television (CCTV). Furthermore, with the development of digital processing technology and the enhancement of data transmission bandwidth, real-time digital image data can be transmitted through a network. The video camera can capture scenes to output digital image data to the computer system in the digital security surveillance equipment through a network. Thus, this digital security surveillance equipment can perform the remote security surveillance in real time.

Such a video camera can be disposed indoors or outdoors, and has an aperture similar to a round hole formed by aperture blades of an aperture stop. In general, the more the quantity of aperture blades is, the more the hole looks circular. In order to capture objects all day long, the aperture size needs to be adjusted according to the ambient environment brightness by moving the aperture blades. Thus, most video cameras can automatically adjust their aperture according to the ambient environment brightness. The greater the aperture size is, the more the light passing through the aperture to reach the image sensor will be. Accordingly, every video camera needs a mainboard circuit to control various iris lenses.

Lens of a video camera is categorized into a DC-IRIS lens or a P-IRIS lens, and the DC-iris lens and the P-iris lens correspond to their specific mainboard circuit model. Thus, the mainboard circuit should be paired with a suitable lens according to the type of the security surveillance equipment. When the mainboard circuit cooperates with an unsuitable lens, the iris system will work abnormal or the internal circuit will be damaged.

### SUMMARY

According to an embodiment, the disclosure provides a video camera driving circuit including a connector, a determination unit and a control chip. The connector outputs an identification signal specifying either a first lens or a second lens which the connector connects to. The determination unit outputs a determination signal according to the identification signal and a reference voltage. According to the determination signal, the control chip outputs a control signal corresponding to either the first lens or the second lens connecting to the connector.

According to an embodiment, the disclosure also provides a video camera driving method including the following steps. Either a first lens or a second lens connects to a connector including a first end, a second end, a third end and a fourth end. The first end of the connector is enabled to be at a high voltage potential, and the fourth end of the connector is enabled to be at a low voltage potential. An identification signal is outputted for specifying either the first lens or the second lens which connects to the connector. A determination signal is outputted according to the identification signal and a reference voltage. A control signal corresponding to either the first lens or the second lens connecting to the connector is outputted according to the determination signal.

### BRIEF DESCRIPTION OF THE DRAWINGS

The present invention will become more fully understood from the detailed description given herein below along with the accompanying drawings which are for illustration only, thus are not limitative of the present invention, and wherein:

FIG. 1 is a block diagram of a video camera driving circuit in the disclosure; and

FIG. 2 is a flowchart of a video camera driving method in the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

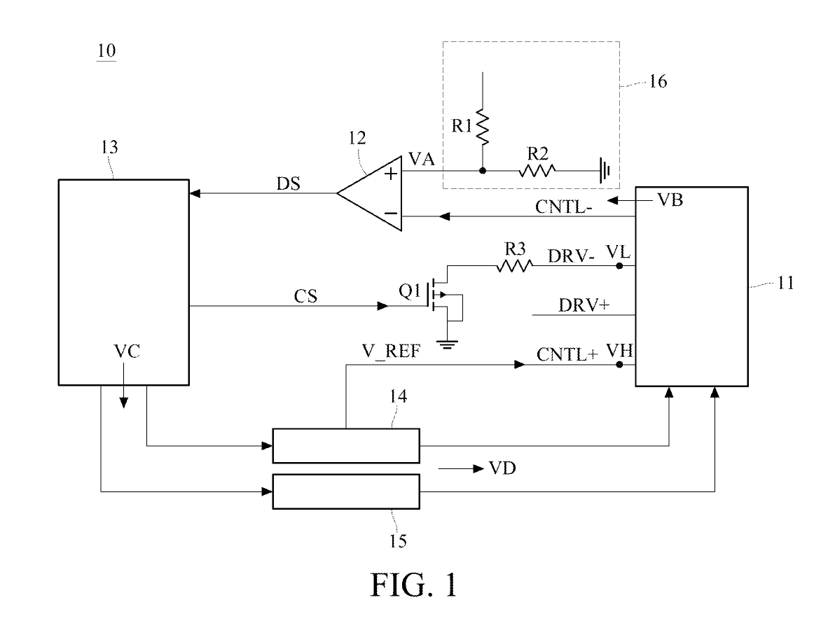

FIG. 1 is a block diagram of a video camera driving circuit in the disclosure. A video camera driving circuit 10 includes a connector 11, a determination unit 12 and a control chip 13. As an example and not by way of limitation, the video camera driving circuit 10 can be applicable to control surveillance cameras.

The connector 11 connects to either a first lens or a second lens. In this and some embodiments, the first lens can be a DC-IRIS lens, and the second lens can be a P-IRIS lens. When either the first lens or the second lens connects to the connector 11, the connector 11 outputs a corresponding identification signal VB which specifies the first lens or the second lens which the connecter 11 connects to. The determination unit 12 outputs a determination signal DS according to the identification signal VB and a reference voltage VA. The control chip 13 outputs a control signal VC according to the determination signal DS, and the control signal VC corresponds to either the first lens or the second lens which connects to the connector 11. Assume that the first lens is a DC-IRIS lens and the second lens is a P-IRIS lens. When the connector 11 connects to the DC-IRIS lens, the control chip 13 outputs the control signal VC corresponding to the DC-IRIS lens, and when the connector 11 connects to the P-IRIS lens, the control chip 13 outputs the control signal VC corresponding to the P-IRIS lens.

The connector 11 includes a first end, a second end, a third end and a fourth end, and these four ends generally specify four different signals CNTL+, CNTL-, DRV+and DRV-respectively. In order to clearly and simply describe the disclosure, the first end to fourth end of the connector 11 are also denoted by the labels CNTL+, CNTL-, DRV+and DRV-respectively. When the video camera driving circuit 10 is triggered, the first end (CNTL+) is enabled to be at a high voltage potential VH, and the fourth end (DRV−) is enabled to be at a low voltage potential VL.

When the connector 11 connects to the first lens, the first end (CNTL+) connects to the second end (CNTL−), and the third end (DRV+) connects to the fourth end (DRV−) through the internal circuit of the first lens. Herein, the first end (CNTL+) is enabled to be at a high voltage potential VH, and the connector 11 makes the second end (CNTL−) to be at the high voltage potential VH through the internal circuit of the first lens as well. Alternately, when the connector 11 connects to the second lens, the first end (CNTL+) connects to the third end (DRV+), and the second end (CNTL−) connects to the fourth end (DRV−) through the internal circuit of the second lens. Herein, the fourth end (DRV−) is enabled to be at the low voltage potential VL, and the connector 11 makes the second end (CNTL−) to be at the low voltage potential VL through the internal circuit of the second lens. In this way, when the connector 11 switches the connection from one lens to another lens, the voltage potential at the second end (CNTL−) will be changed and be set as the determination signal VB transmitted to the determination unit 12. This internal circuit hereinafter includes a circuit board and some electric components and is used for converting signals according to various lenses.

Furthermore, the video camera driving circuit 10 further includes a third resistor R3 and a first transistor Q1. The third resistor R3 has a first end and a second end, and the first end of the third resistor R3 electrically connects to the fourth end (DRV−) of the connector 11. The first transistor Q1 has a control end, a first end and a second end, the first end of the first transistor Q1 electrically connects to the second end of the third resistor R3, the second end of the first transistor Q1 is grounded, and the control end of the first transistor Q1 receives a control signal CS outputted by the control chip 13. When being triggered, the control chip 13 outputs the control signal CS to turn on the first transistor Q1, and then the fourth end (DRV−) is at the low voltage potential VL.

The video camera driving circuit 10 further includes a first driving circuit 14 and a second driving circuit 15 which electrically connect to the control chip 13. Either the first driving circuit 14 or the second driving circuit 15 outputs a driving signal VD according to the control signal VC. The first end (CNTL+) of the connector 11 is enabled by a second reference voltage V_REF outputted by the first driving circuit 14, to be at the high voltage potential VH. When the connector 11 connects to the first lens, the first driving circuit 14 outputs the driving signal VD corresponding to the first lens. When the connector 11 connects to the second lens, the second driving circuit 15 outputs the driving signal VD corresponding to the second lens.

The video camera driving circuit 10 further includes a voltage division circuit 16 electrically connecting to the determination unit 12, for supplying a reference voltage VA. The voltage division circuit 16 includes a first resistor R1 and a second resistor R2. The first resistor R1 has a first end and a second end, and the first end of the first resistor R1 electrically connects to a power source. The second resistor R2 has a first end and a second end, the first end of the second resistor R2 is grounded, and the second end of the second resistor R2 electrically connects to the second end of the first resistor R1. The voltage division circuit 16 supplies the reference voltage VA to the determination unit 12.

The determination unit 12 can be an operational amplifier in this and some embodiments and have a positive input end (+) and a negative input end (−). The positive input end of the determination unit 12 is supplied with the reference voltage VA, and the negative input end of the determination unit 12 is supplied with the identification signal VB. Herein, the determination unit 12 compares the identification signal VB and the reference voltage VA to output the determination signal DS.

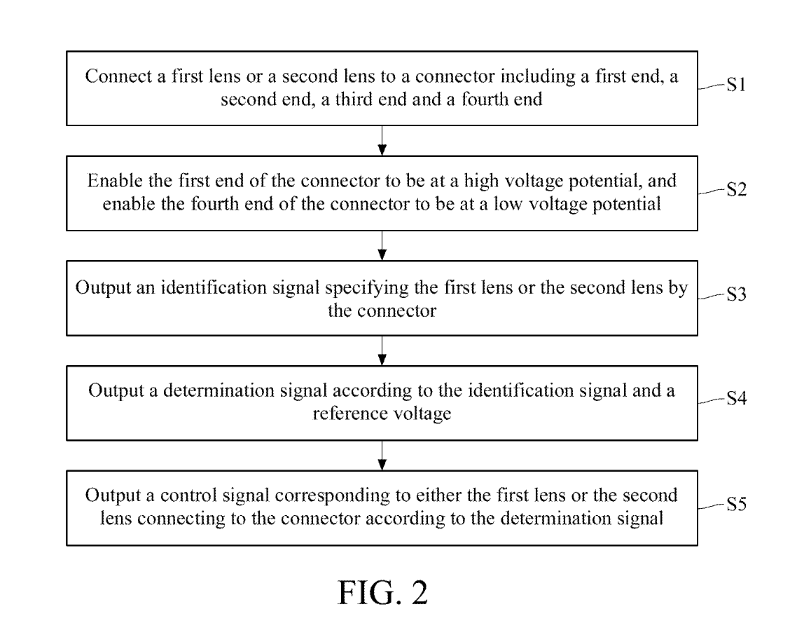

The operation of the video camera driving circuit 10 is described as follows. FIG. 2 is a flowchart of a video camera driving method in the disclosure. Firstly, the connector 11 connects to either the first lens, i.e. a DC-IRIS lens, or the second lens, i.e. a P-IRIS lens (step S1), where the connector 11 includes the first end (CNTL+), the second end (CNTL−), the third end (DRV+) and the fourth end (DRV−). Then, the first end (CNTL+) is enabled to be at the high voltage potential VH, and the fourth end (DRV−) is enabled to be at the low voltage potential VL (step S2). Herein, output the identification signal VB corresponding to either the first lens or the second lens which the connector connects to, by the connector (step S3), and then output a determination signal DS according to the identification signal VB and the reference voltage VA (step S4). Finally, output the control signal VC according to the determination signal DS, and the control signal VC corresponds to the lens connecting to the connector 11 (step S5).

The detail of the video camera driving method is described as follows. Firstly, the connector 11 connects to either the first lens or the second lens. When the control chip 13 is triggered, the control chip 13 outputs the control signal CS to turn on the first transistor Q1. Herein, the fourth end (DRV−) is enabled to be at the low voltage potential VL by using the third resistor R3 and the first transistor Q1. Meanwhile, the control chip 13 outputs the control signal VC to the first driving circuit 14, and the first driving circuit 14 outputs the second reference voltage V_REF to the first end (CNTL+). When the first end (CNTL+) is supplied with the second reference voltage V_REF, the internal circuit of the lens transfers the second reference voltage V_REF to the second end (CNTL−). Accordingly, the voltage potential, i.e. the identification signal VB, at the second end (CNTL−) is based on the lens connecting to the connector 11.

Specifically, when the connector 11 connects to the first lens, the first end (CNTL+) connects to the second end (CNTL−), and the third end (DRV+) connects to the fourth end (DRV−) through the internal circuit of the first lens. The first end (CNTL+) is enabled to be at the high voltage potential VH, and the second end (CNTL−) then becomes the high voltage potential VH after the internal circuit of the first lens transfers the signal. When the connector 11 connects to the second lens, the first end (CNTL+) connects to the third end (DRV+), and the second end (CNTL−) connects to the fourth end (DRV−) through the internal circuit of the second lens. Herein, the fourth end (DRV−) is enabled to be at the low voltage potential VL and the second end (CNTL−) then becomes at the low voltage potential VL after the internal circuit of the second lens transfers the signal.

Finally, the determination unit 12 outputs the determination signal DS according to the identification signal VB and the reference voltage VA. The control chip 13 can determine the type of the connected lens according to the determination signal DS. If the determination signal DS specifies the first lens, the control chip 13 will output the control signal VC corresponding to the first lens rather than the second, the first driving circuit 14 will output the driving signal VD corresponding to the first lens to drive the first lens according to the control signal VC. If the determination signal DS specifies the second lens, the control chip 13 will output the control signal VC corresponding to the second lens in stead of the first lens, the second driving circuit 15 will output the driving signal VD corresponding to the second lens to drive the second lens according to the control signal VC.

According to the above video camera driving circuit and the above video camera driving method, the disclosure can support the DC-IRIS lens and the P-IRIS lens and their iris systems. In this way, the motherboard may be more universal, control the iris systems normally and avoid the internal circuit being damaged.

What is claimed is:

1. A video camera driving circuit, comprising:
a connector, configured to output an identification signal specifying either a first lens or a second lens which the connector connects to;
a determination unit, configured to output a determination signal according to the identification signal and a reference voltage; and
a control chip, configured to output a control signal corresponding to either the first lens or the second lens connecting to the connector, according to the determination signal.

2. The video camera driving circuit according to claim 1, wherein the connector comprises a first end, a second end, a third end and a fourth end, and when the video camera driving circuit is triggered, the first end of the connector is at a high voltage potential, and the fourth end of the connector is at a low voltage potential.

3. The video camera driving circuit according to claim 2, wherein when the connector connects to the first lens, the first end and the second end of the connector are connected and the third end and the fourth end of the connector are connected.

4. The video camera driving circuit according to claim 2, wherein, when the connector connects to the second lens, the first end and the third end of the connector are connected and the second end and the fourth end of the connector are connected.

5. The video camera driving circuit according to claim 2, further comprising:
a third resistor having a first end and a second end, and the first end of the third resistor electrically connecting to the fourth end of the connector; and
a first transistor having a control end, a first end and a second end, wherein the first end of the first transistor electrically connects to the second end of the third resistor, the second end of the first transistor is grounded, and when the control end of the first transistor receives the control signal, the first transistor turns on and the fourth end of the connector is at the low voltage potential.

6. The video camera driving circuit according to claim 2, further comprising a first driving circuit and a second driving circuit both of which electrically connect to the control chip and are configured to output a driving signal according to the control signal.

7. The video camera driving circuit according to claim 6, wherein the first end of the connector is enabled to be at the high voltage potential according to a second reference voltage outputted by the first driving circuit.

8. The video camera driving circuit according to claim 1, wherein the determination unit is an operational amplifier having a positive input end and a negative input end, the positive input end receives the reference voltage, and the negative input end receives the identification signal.

9. The video camera driving circuit according to claim 1, further comprising:
a voltage division circuit, electrically connecting to the determination unit and configured to output the reference voltage.

10. The video camera driving circuit according to claim 9, wherein the voltage division circuit comprises:
a first resistor having a first end and a second end, and the first end of the first resistor electrically connecting to a power source; and
a second resistor having a first end and a second end, the first end of the second resistor being grounded, and the second end of the second resistor electrically connecting to the second end of the first resistor.

11. A video camera driving method, comprising:
connecting either a first lens or a second lens to a connector comprising a first end, a second end, a third end and a fourth end;
enabling the first end of the connector to be at a high voltage potential, and enabling the fourth end of the connector to be at a low voltage potential;
outputting an identification signal specifying either the first lens or the second lens which the connector connects to, via the connector;
outputting a determination signal according to the identification signal and a reference voltage; and
outputting a control signal corresponding to either the first lens or the second lens connecting to the connector, according to the determination signal.
